(19) United States
(12) Patent Application Publication
(10) Pub. No.: US 2025/0158662 A1
(43) Pub. Date: May 15, 2025

(54) APPROACHES FOR CONTROL OF A RADIO REFLECTOR

(71) Applicant: Telefonaktiebolaget LM Ericsson (publ), Stockholm (SE)

(72) Inventors: Bruno SOKAL, Fortaleza (BR); Paulo Ricardo Barboza GOMES, Fortaleza (BR); André L. F. DE ALMEIDA, Fortaleza (BR); Gabor FODOR, Hässelby (SE); Behrooz MAKKI, Pixbo (SE)

(73) Assignee: Telefonaktiebolaget LM Ericsson (publ), Stockholm (SE)

(21) Appl. No.: 18/838,869

(22) PCT Filed: Mar. 1, 2022
(86) PCT No.: PCT/EP2022/055035

§ 371 Date: Aug. 15, 2024

(51) Int. Cl. H04B 7/04; H04L 25/02

(52) U.S. Cl. CPC H04B 7/04013; H04L 25/0248

(57) ABSTRACT

A first method is disclosed, which is performed in a first node. The method is for controlling a radio reflector of a second node by using a first plurality, N, of control coefficients. The radio reflector comprises reflector elements, and each reflector element is controllable by a respective one of the control coefficients. The method comprises representing the first plurality of control coefficients by a second plurality of approximation coefficients for transmission to the second node, wherein the second plurality is smaller than the first plurality, and wherein the second plurality of approximation coefficients comprises two or more, P, groups of approximation coefficients, each group representing a low rank approximation (LRA) of the first plurality of control coefficients, and each group comprising a respective third plurality, Rₚ, of collections of approximation coefficients. A second method is also disclosed, which is performed in the second node. The method comprises receiving the second plurality of approximation coefficients from the first node, and determining an estimation of the first plurality of control coefficients based on the second plurality of approximation coefficients. A third method is also disclosed, which is performed in a third node. The method comprises determining one or more parameters associated with the second plurality of approximation coefficients, and providing the one or more determined parameters to the first node. Corresponding computer program product, apparatuses, nodes, system, and signaling message are also disclosed.

### TECHNICAL FIELD

The present disclosure relates generally to the field of wireless communication. More particularly, it relates to control of radio reflectors deployed in a wireless communication system.

### BACKGROUND

Radio reflectors may be used to improve coverage and/or quality of service in wireless communication systems. To this end, dynamically controllable radio reflectors may be particularly beneficial, since they can be adapted to varying channel conditions and/or varying service needs in a wireless communication system.

Typically, a dynamically controllable radio reflector may comprise a plurality of reflector elements, and each reflector element may be (e.g., individually) controllable by a respective control coefficient. Intelligent reflecting surfaces (IRS)—sometimes referred to reconfigurable intelligent surfaces (RIS)—are examples of dynamically controllable radio reflectors.

In a typical situation, a first node of a wireless communication system determines the control coefficients and transmits them to a second node of the a wireless communication system, while the second node comprises (or is connected to) the radio reflector and uses the received control coefficients to control the radio reflector. The conveyance of control coefficients may be referred to as “feedback”. The determination and transmission of control coefficients may be repeatedly performed to implement dynamic control of the radio reflector.

The signaling overhead introduced by transmission of the control coefficients is typically non-negligible. In some scenarios, the signaling overhead introduced by transmission of the control coefficients may be substantial in some scenarios. Thus, while the use of dynamically controllable radio reflectors may improve coverage and/or quality of service in wireless communication systems, performance (e.g., in terms of capacity, throughput, etc.) of the wireless communication system may be impaired by the transmission of the control coefficients.

Therefore, there is a need for alternative approaches for radio reflector control.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like.

It is an object of some embodiments to solve or mitigate, alleviate, or eliminate at least some of the above or other disadvantages.

A first aspect is a method performed in a first node, for controlling a radio reflector of a second node by using a first plurality, N, of control coefficients, wherein the radio reflector comprises reflector elements, each reflector element being controllable by a respective one of the control coefficients.

The method comprises representing the first plurality of control coefficients by a second plurality of approximation coefficients for transmission to the second node, wherein the second plurality is smaller than the first plurality, and wherein the second plurality of approximation coefficients comprises two or more, P, groups of approximation coefficients, each group representing a low rank approximation, LRA, of the first plurality of control coefficients, and each group comprising a respective third plurality, Rₚ, of collections of approximation coefficients.

In some embodiments, the method further comprises transmitting the approximation coefficients to the second node to control the radio reflector.

In some embodiments, the method further comprises transmitting information indicative of one or more parameters associated with the second plurality of approximation coefficients to the second node.

In some embodiments, representing the first plurality of control coefficients by the second plurality of approximation coefficients comprises performing, for each of the two or more groups, LRA based on the first plurality of control coefficients.

In some embodiments, representing the first plurality of control coefficients by the second plurality of approximation coefficients further comprises rearranging the first plurality of control coefficients for each of the two or more groups before performing the LRA.

In some embodiments, performing the LRA comprises performing one or more of: a singular value decomposition (SVD), a higher order singular value decomposition (HOSVD), and an alternating least squares (ALS) algorithm.

In some embodiments, the method further comprises determining one or more of: a number of groups, a number of collections of each group, a number of approximation coefficients of each collection for each group, and a resolution for representing approximation coefficients for each group.

In some embodiments, determining the number of groups comprises one or more of: increasing the number of groups to decrease a size of the second plurality, and decreasing the number of groups to improve the representation of the first plurality of control coefficients by the second plurality of approximation coefficients.

In some embodiments, determining the number of collections of each group comprises one or more of: determining the number of collections to be the same for all groups, determining the number of collections to be different for at least two of the groups, determining the number of collections of a group to equal, or exceed, a channel rank, increasing the number of collections of a group to increase an accuracy of the LRA, and decreasing the number of collections of a group to decrease a size of the second plurality.

In some embodiments, determining the number of approximation coefficients of each collection for each group comprises one or more of: determining the number of approximation coefficients of each collection for each group so that a product over all groups of the number of approximation coefficients of each collection equals the first plurality, determining the number of approximation coefficients of each collection for each group so that a sum over all groups of the number of approximation coefficients of each collection is maximized, determining the number of approximation coefficients of each collection for each group so that the number of approximation coefficients of each collection for a first one of the groups equals a highest divisor of the first plurality, and determining the number of approximation coefficients of each collection for each group so that the number of approximation coefficients of each collection for a second one of the groups equals a next highest divisor of the first plurality.

In some embodiments, determining the resolution for representing approximation coefficients for each group comprises one or more of: determining the resolution for representing approximation coefficients to be the same for all groups, determining the resolution for representing approximation coefficients to be different for at least two of the groups, increasing the resolution for representing approximation coefficients for at least one of the groups when the number of collections for each group is decreased, and determining the resolution for representing approximation coefficients for a first group to be higher than the resolution for representing approximation coefficients for a second group when the number of approximation coefficients of each collection for the first group is lower than the number of approximation coefficients of each collection for the second group.

In some embodiments, the determination is performed responsive to one or more of: elapse of a specific time duration since a previous determination, and occurrence of a triggering event.

In some embodiments, the determination is based on one or more of: a payload size of a packet for transmission of the approximation coefficients, an available capacity for transmission of the approximation coefficients, a traffic load on a channel used for transmission of the approximation coefficients, an update rate for the radio reflector control, a channel variability, an accuracy for the radio reflector control, and a number of users for which approximation coefficients are to be provided.

In some embodiments, representing the first plurality of control coefficients by the second plurality of approximation coefficients comprises one or more of: normalizing each of the approximation coefficients, and quantizing each of the approximation coefficients.

In some embodiments, the method further comprises calculating the first plurality of control coefficients based on a channel estimation.

In some embodiments, the first plurality of control coefficients represents absolute, or differential, phase values for the reflector elements.

In some embodiments, the method further comprises receiving reference signals as reflected by the radio reflector, and performing channel estimation based on the received reference signals.

In some embodiments, the reference signals are reflected by the radio reflector with reflector elements configured according to one or more of: random control coefficient values, default control coefficient values, and previously provided control coefficient values.

In some embodiments, the method further comprises one or more of: increasing an update rate for the radio reflector control when a size of the second plurality is decreased, multiplexing approximation coefficients of two or more users within a same channel, and reducing a bandwidth and/or power used for transmission of approximation coefficients when a size of the second plurality is decreased.

In some embodiments, one or more parameters associated with the second plurality of approximation coefficients differs for different dimensions of control and/or for different subsets of the reflector elements of the radio reflector.

In some embodiments, the first plurality of control coefficients corresponds to all reflector elements of the radio reflector.

In some embodiments, the first plurality of control coefficients corresponds to a subset of the reflector elements of the radio reflector.

In some embodiments, the method further comprises transmitting, to the second node, information indicative of one or more of: a number of subsets used, a first plurality size for each subset used, and one or more parameters associated with the second plurality of approximation coefficients for each subset used.

A second aspect is a method performed in a second node, for controlling a radio reflector of the second node by using a first plurality, N, of control coefficients, wherein the radio reflector comprises reflector elements, each reflector element being controllable by a respective one of the control coefficients.

he method comprises receiving a second plurality of approximation coefficients from a first node, wherein the second plurality of approximation coefficients represents the first plurality of control coefficients, wherein the second plurality is smaller than the first plurality, and wherein the second plurality of approximation coefficients comprises two or more, P, groups of approximation coefficients, each group representing a low rank approximation, LRA, of the first plurality of control coefficients, and each group comprising a respective third plurality, Rₚ, of collections of approximation coefficients, and determining an estimation of the first plurality of control coefficients based on the second plurality of approximation coefficients.

In some embodiments, the method further comprises controlling the reflector elements based on the estimation of the first plurality of control coefficients.

In some embodiments, the method further comprises receiving information indicative of one or more parameters associated with the second plurality of approximation coefficients from the first node, wherein determining the estimation of the first plurality of control coefficients is further based the information.

In some embodiments, determining the estimation of the first plurality of control coefficients based on the second plurality of approximation coefficients comprises calculating a number of Kronecker products of collections of approximation coefficients, and determining a (possibly weighted) sum of the calculated Kronecker products.

In some embodiments, the method further comprises causing reference signals to be reflected by the radio reflector for channel estimation by the first node.

In some embodiments, the reference signals are reflected by the radio reflector with reflector elements configured according to one or more of: random control coefficient values, default control coefficient values, and previously provided control coefficient values.

In some embodiments, the first plurality of control coefficients corresponds to a subset of the reflector elements of the radio reflector.

In some embodiments, the method further comprises receiving, from the first node, information indicative of one or more of: a number of subsets used, a first plurality size for each subset used, and one or more parameters associated with the second plurality of approximation coefficients for each subset used.

In some embodiments, the method further comprises concatenating the estimations of the first plurality of control coefficients for all used subsets.

A third aspect is a method performed in a third node, for controlling a radio reflector of a second node by using a first plurality, N, of control coefficients, wherein the radio reflector comprises reflector elements, each reflector element being controllable by a respective one of the control coefficients.

The first plurality of control coefficients are representable by a second plurality of approximation coefficients for transmission from a first node to the second node, wherein the second plurality is smaller than the first plurality, and wherein the second plurality of approximation coefficients comprises two or more, P, groups of approximation coefficients, each group representing a low rank approximation, LRA, of the first plurality of control coefficients, and each group comprising a respective third plurality, Rₚ, of collections of approximation coefficients.

The method comprises determining one or more parameters associated with the second plurality of approximation coefficients, and providing the one or more determined parameters to the first node.

In some embodiments, determining one or more parameters associated with the second plurality of approximation coefficients comprises determining one or more of: a number of groups, a number of collections of each group, a number of approximation coefficients of each collection for each group, and a resolution for representing approximation coefficients for each group.

A fourth aspect is a computer program product comprising a non-transitory computer readable medium, having thereon a computer program comprising program instructions. The computer program is loadable into a data processing unit and configured to cause execution of the method according to any of the first, second, and third aspects when the computer program is run by the data processing unit.

A fifth aspect is an apparatus for a first node, for controlling a radio reflector of a second node by using a first plurality, N, of control coefficients, wherein the radio reflector comprises reflector elements, each reflector element being controllable by a respective one of the control coefficients.

The apparatus comprises controlling circuitry configured to cause representation of the first plurality of control coefficients by a second plurality of approximation coefficients for transmission to the second node, wherein the second plurality is smaller than the first plurality, and wherein the second plurality of approximation coefficients comprises two or more, P, groups of approximation coefficients, each group representing a low rank approximation, LRA, of the first plurality of control coefficients, and each group comprising a respective third plurality, Rₚ, of collections of approximation coefficients.

A sixth aspect is a control node comprising the apparatus of the fifth aspect.

In some embodiments, the control node is a network node (e.g., a radio access node).

A seventh aspect is an apparatus for a second node, for controlling a radio reflector of the second node by using a first plurality, N, of control coefficients, wherein the radio reflector comprises reflector elements, each reflector element being controllable by a respective one of the control coefficients.

The apparatus comprises controlling circuitry configured to cause reception of a second plurality of approximation coefficients from a first node, wherein the second plurality of approximation coefficients represents the first plurality of control coefficients, wherein the second plurality is smaller than the first plurality, and wherein the second plurality of approximation coefficients comprises two or more, P, groups of approximation coefficients, each group representing a low rank approximation, LRA, of the first plurality of control coefficients, and each group comprising a respective third plurality, Rₚ, of collections of approximation coefficients, and determination of an estimation of the first plurality of control coefficients based on the second plurality of approximation coefficients.

An eighth aspect is a reflector node comprising the apparatus of the seventh aspect.

In some embodiments, the reflector node further comprises the radio reflector.

In some embodiments, the radio reflector comprises an intelligent reflecting surface, IRS, and/or a reconfigurable intelligent surface, RIS.

In some embodiments, the reflector elements comprise a multitude of discrete element units of a reflector panel, or a multitude of elemental areas of a continuous reflector surface.

A ninth aspect is an apparatus for a third node, for controlling a radio reflector of a second node by using a first plurality, N, of control coefficients, wherein the radio reflector comprises reflector elements, each reflector element being controllable by a respective one of the control coefficients.

The first plurality of control coefficients are representable by a second plurality of approximation coefficients for transmission from a first node to the second node, wherein the second plurality is smaller than the first plurality, and wherein the second plurality of approximation coefficients comprises two or more, P, groups of approximation coefficients, each group representing a low rank approximation, LRA, of the first plurality of control coefficients, and each group comprising a respective third plurality, Rₚ, of collections of approximation coefficients.

The apparatus comprises controlling circuitry configured to cause determination of one or more parameters associated with the second plurality of approximation coefficients, and provision of the one or more determined parameters to the first node.

A tenth aspect is a control node comprising the apparatus of the ninth aspect.

In some embodiments, the control node is a network node (e.g., a central node).

An eleventh aspect is a wireless communication system comprising the control node of the sixth aspect, and the reflector node of the eighth aspect.

In some embodiments, the wireless communication system further comprises the control node of the tenth aspect.

A twelfth aspect is a signaling message configured to be transmitted by a first node and received by a second node, for controlling a radio reflector of the second node by using a first plurality, N, of control coefficients, wherein the radio reflector comprises reflector elements, each reflector element being controllable by a respective one of the control coefficients.

The signaling message comprises a payload portion configured to convey a second plurality of approximation coefficients representing the first plurality of control coefficients, wherein the second plurality is smaller than the first plurality, and wherein the second plurality of approximation coefficients comprises two or more, P, groups of approximation coefficients, each group representing a low rank approximation, LRA, of the first plurality of control coefficients, and each group comprising a respective third plurality, Rₚ, of collections of approximation coefficients, and a preamble portion preceding the payload portion, and configured to convey information indicative of one or more parameters associated with the second plurality of approximation coefficients to the second node.

In some embodiments, the signaling message is configured to be comprised in one or more of; a radio resource control (RRC) message, a medium access control (MAC) message, and a relay type message.

In some embodiments, any of the above aspects may additionally have features identical with or corresponding to any of the various features as explained above for any of the other aspects.

An advantage of some embodiments is that alternative approaches for radio reflector control are provided.

An advantage of some embodiments is that the signaling overhead, which is introduced by transmission of information for conveying the control coefficients, is reduced compared to other approaches (e.g., compared to direct transmission of the control coefficients).

An advantage of some embodiments is that performance (e.g., in terms of capacity, throughput, etc.) of the wireless communication system may be improved compared to other approaches (e.g., compared to direct transmission of the control coefficients).

An advantage of some embodiments is that an update rate for the radio reflector control may be increased compared to other approaches (e.g., compared to direct transmission of the control coefficients). For example, the update rate for the radio reflector control may be increased while the same amount of signaling overhead as in other approaches is used.

An advantage of some embodiments is that approximation coefficients of two or more users may be multiplexed within a same channel. Thereby, more users may be accommodated compared to other approaches (e.g., compared to direct transmission of the control coefficients). For example, the number of users may be increased while the same amount of signaling overhead as in other approaches is used.

An advantage of some embodiments is that bandwidth and/or power used for transmission of approximation coefficients may be reduced compared to other approaches (e.g., compared to direct transmission of the control coefficients).

An advantage of some embodiments is that a trade-off between signaling overhead and control accuracy is provided.

An advantage of some embodiments is that the signaling overhead may be dynamically adapted. For example, adaptation may be based on one or more current conditions of the wireless communication system (e.g., traffic load, number or users, channel conditions, etc.).

An advantage of some embodiments is that the flexibility (e.g., in terms of degrees of freedom) is increased compared to other approaches (e.g., compared to direct transmission of the control coefficients). This may enable the network comprising the radio reflector to operate under different feedback-aware signaling schemes, where each scheme represents a low-rank factorization model with different combinations of parameter values.

An advantage of some embodiments is that the wireless communication system may operate with significantly reduced feedback signaling overhead, and/or with increased resolution for each coefficient, and/or with more frequent feedback updates.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a schematic drawing illustrating an example wireless communication system according to some embodiments;

FIG. 2 is a signaling diagram illustrating example signaling according to some embodiments;

FIG. 3 is a flowchart illustrating example method steps according to some embodiments;

FIG. 4 is a flowchart illustrating example method steps according to some embodiments;

FIG. 5 is a schematic drawing illustrating an example format for a signaling message according to some embodiments;

FIG. 6 is a schematic block diagram illustrating an example approach for representing a first plurality of control coefficients by a second plurality of approximation coefficients according to some embodiments;

FIG. 7 is a schematic block diagram illustrating an example apparatus according to some embodiments;

FIG. 8 is a schematic block diagram illustrating an example apparatus according to some embodiments;

FIGS. 9A-C are simulation plots illustrating example results achievable according to some embodiments; and

FIG. 10 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, embodiments will be described that aim to convey control coefficients in a compressed manner from a first node to a second node, for controlling a radio reflector of the second node. The radio reflector comprises reflector elements, and each reflector element is controllable by a respective one of the control coefficients.

Generally, the signaling for radio reflector control described herein may be conveyed using any suitable physical and/or logical channel, e.g., a control channel. For example, a feedback control channel may be suitable for conveying the approximation coefficients that are used to represent the control coefficients in a compressed manner.

Also generally, when a radio reflector is referred to herein, it may comprise any suitable radio reflector. For example, the radio reflector may comprise an intelligent reflecting surface (IRS) or a reconfigurable intelligent surface (RIS).

Typically, the reflector elements comprise a multitude of discrete element units of a reflector panel, or a multitude of elemental areas of a continuous reflector surface (e.g., a graphene-based structure). In any case, the control of each reflector element using the respective control coefficient may take any suitable form. For example, a reflector element may be controlled by varying an impedance of the reflector element based on the respective control coefficient, or by setting the reflector element in an “on” state or an “off” state (e.g., using a switching mechanism, which can, for example, be implemented by a diode) based on the respective control coefficient.

The signaling for radio reflector control described herein may be applicable for any suitable wireless communication system configured to include controllable radio reflectors. For example, the signaling for radio reflector control may be applicable for wireless communication system as specified by the Third Generation Partnership Project (3GPP; e.g., beyond fifth generation—B5G, sixth generation—6G, etc.).

For example, intelligent reflecting surfaces (IRS) represent a promising technology for B5G and 6G wireless communications, since they enable dynamic shaping of the radio propagation environment via their ability to control the properties of electromagnetic waves.

Alternatively or additionally, the signaling for radio reflector control described herein may be applicable for SISO (Single-Input Single-Output) systems and/or for MIMO (Multiple-Input Multiple-Output) systems.

An IRS may basically comprise two main parts.

A first main part (which may be comprised in the radio reflector, as described later) may be a large panel containing n=1, . . . , N reflecting units (reflector elements). Each of them is typically responsible for implementing a specific phase shift θₙ.

A second main part (which may be comprised in the radio reflector or in the reflector node, as described later) may be an IRS controller, that is responsible to configure the phase shifts for each reflecting unit.

The ensemble of phase shifts for the panel may be represented as a phase-shift vector s=[e^{jθ}^{₁}, . . . , e^{jθ}^{_{N}}]∈ [symbol] ^{N×1}, where j=\sqrt{−1}, and [symbol] represents the space of complex numbers.

Some advantages that may be achieved when using IRS assisted wireless communication networks are high energy efficiency and/or low cost compared to other technologies (e.g., amplify-and-forward relays, decode-and-forward relays, etc.). This is due to that the reflecting units are typically semi-passive, and no radio frequency (RF) chain is required for implementation. It may be noted that the IRS will typically consume some energy even in its simplest form (e.g., for phase shift adjustment), but there are typically no active components (e.g., amplifiers, etc.) comprised in the IRS.

Another advantage that may be achieved when using IRS assisted wireless communication networks is simplified deployment compared to other technologies. This is due to that there is high flexibility enabling gradual improvement of network performance by adding and/or upgrading IRS(s) without affecting the rest of the network infrastructure.

However, channel estimation and IRS phase shift optimization typically need to be performed at some system node (e.g., a first node) that provides control coefficients for the IRS. Optimized phase shifts (e.g., in the form of control coefficients) may be quantized and provided to the IRS; e.g., via a feedback control channel with limited capacity. Depending on the number of reflecting units at the IRS (which usually varies from hundreds to thousands of reflector elements), and on the number of bits representing the phase shift for each reflecting unit, the IRS feedback load typically causes considerable signaling overhead in the network.

This is one motivation for some embodiments to aim for conveyance of control coefficients in a compressed manner. For example, if it is assumed that the duration of time TF needed for provision of the feedback (i.e., the control coefficients) may be represented by

$${T}_{F} = Nb / {B}_{F} {log}_{2} ( 1 + \frac{{p}_{F} {\vert {h}_{F} \vert}^{2}}{{N}_{0} {B}_{F}} ) ,$$

where N is the number of control coefficients, b is the number of bits representing each control coefficient, B_{F} is the bandwidth of the feedback channel, p_{F} is the power for feedback transmission, h_{F} represents the feedback channel, and N₀ represents noise, the duration of time needed for provision of the feedback may be reduced by reducing the number of coefficients transmitted and/or the number of bits representing each coefficient. Such reductions should preferably not severely impair the accuracy of the IRS control.

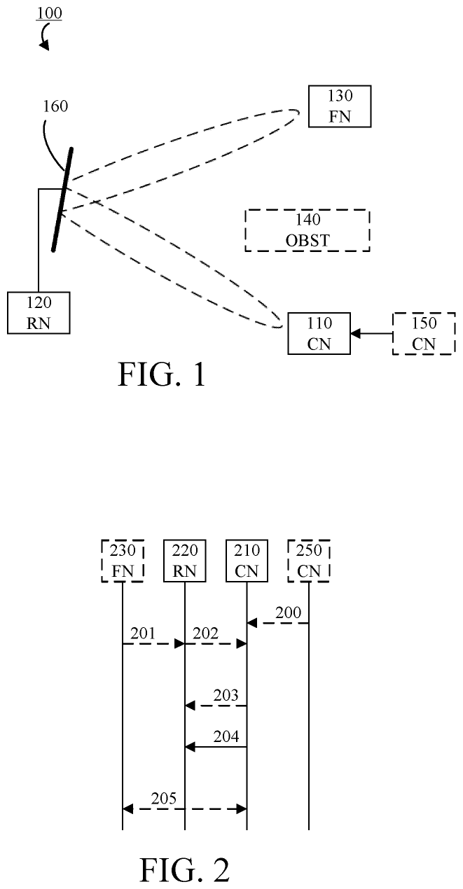

FIG. 1 schematically illustrates (a portion of) an example wireless communication system 100 according to some embodiments. The wireless communication system 100 comprises a first node in the form of a control node (CN; e.g., a network node, such as a radio access node, or a user equipment, UE) 110 and a second node in the form of a reflector node (RN; e.g., a network node) 120. The reflector node 120 is operatively connected to a radio reflector 160. For example, the reflector node may comprise the radio reflector 160.

The control node 110 is configured to communicate with a further node (FN; e.g., a network node, such as a radio access node, a user equipment, UE) 130 via the radio reflector 160. For example, the radio reflector 160 may be beneficial when there is an obstacle (OBST) 140 blocking a line-of-sight between the control node 110 and the further node 130. The radio reflector 160 may be controlled with the aim to optimize a signaling path for communication between the control node 110 and the further node 130, via the radio reflector 160.

The control node 110 is also configured to convey control coefficients to the reflector node 120, for controlling the radio reflector 160. As will be exemplified in the following, the control node 110 is configured to convey the control coefficients to the reflector node 120 in a compressed manner.

The compression may be dependent on one or more parameter values. The parameter values may be determined (e.g., dynamically) by the control node 110. Alternatively or additionally, the wireless communication system 100 may comprise a third node in the form of another control node (CN; e.g., a network node, such as a central node) 150.

The control node 150 may be configured to determine (e.g., dynamically) the parameter values and provide (e.g., transmit) them to the control node 110.

Generally, a radio access node may be any suitable radio access node (e.g., a base station, BS, a radio unit, RU, an access point, AP, etc.), and a central node may be any suitable central node (e.g., a server node, a cloud-implementing node, etc.).

Also generally, any node described herein as having a certain function may, additionally, have other functions as well. For example, the reflector node 120 may also have radio access node functionality, the control node 150 may also have radio access node functionality, etc.

Also generally, embodiments may be equally applicable for uplink communication (e.g., UE to BS), downlink communication (e.g., BS to UE), device to device communication (e.g., UE to UE), and network node to network node communication (e.g., BS to BS).

FIG. 2 schematically illustrates example signaling according to some embodiments, between a control node (CN) 210 (compare with 110 of FIG. 1) and a reflector node (RN) 220 (compare with 120 of FIG. 1).

Optionally, the signaling may start with that another control node (CN) 250 (compare with 150 of FIG. 1) provides one or more parameter values for compression to the control node 210, as illustrated by 200.

A further node (FN) 230 (compare with 130 of FIG. 1)−with which the control node 210 is configured to communicate via a radio reflector of the reflector node 220—may transmit reference signals, as illustrated by 201, which are reflected by the radio reflector of the reflector node 220, as illustrated by 202.

The control node 210 can use the received reference signals to calculate the control coefficients using any suitable approach. Then, the control node 210 applies compression to the control coefficients based on one or more parameter values for compression (e.g., provided from the control node 150 at 200, or determined by the control node 210).

The control coefficients in compressed form are transmitted from the control node 210 to the reflector node 220, as illustrated by 204. Optionally, information indicative of the one or more parameters is also transmitted from the control node 210 to the reflector node 220, as illustrated by 203. The transmissions 203 and 204 may be implemented as a single transmission or as two separate transmissions. Alternatively or additionally, the transmission 203 may be performed each time the transmission 204 is performed, or more seldom than the transmission 204 is performed. For example, the transmission 203 may be performed when a parameter value is altered and/or at some predetermined time interval.

The reflector node 220 can use the control coefficients in compressed form for controlling the radio reflector. Then, communication between the control node 210 and the further node 130 may be conducted via the radio reflector of the reflector node 220, as illustrated by 205.

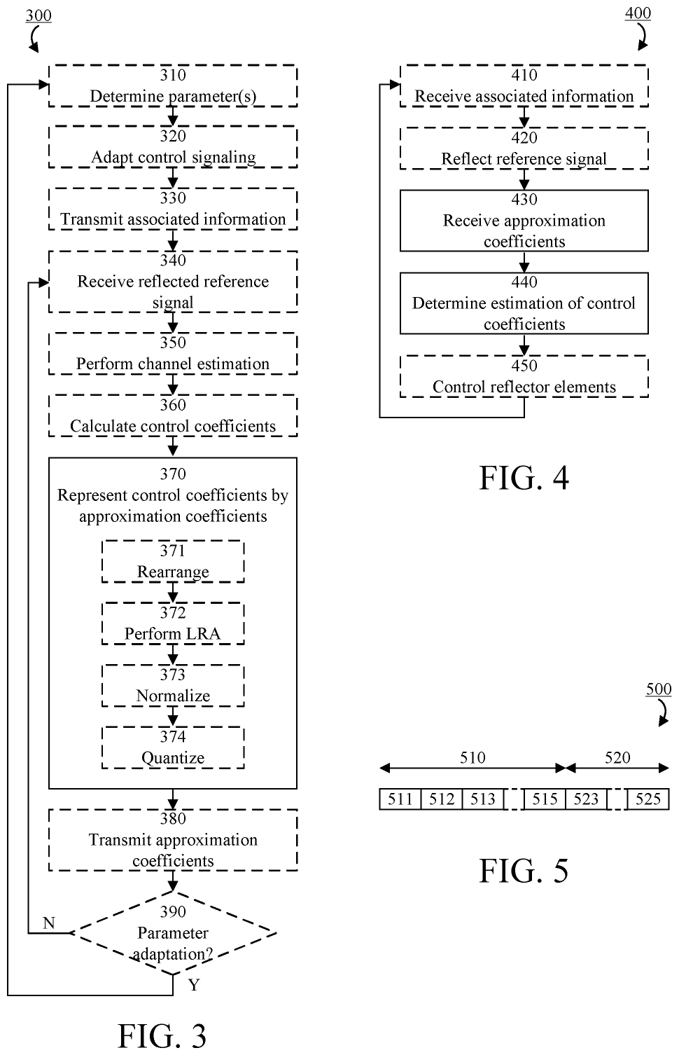

FIG. 3 illustrates an example method 300 according to some embodiments. The method 300 is performed in a first node (e.g., the control node 110 of FIG. 1 and/or the control node 210 of FIG. 2), for controlling a radio reflector of a second node (e.g., the reflector node 120 of FIG. 1 and/or the reflector node 220 of FIG. 2).

The control of the radio reflector is performed by using a first plurality, N>1, of control coefficients, wherein the radio reflector comprises reflector elements, and each reflector element is controllable by a respective one of the control coefficients.

The first plurality of control coefficients may, for example, represent absolute, or differential, values for the reflector elements. When a control element represents an absolute value for the reflector element, the reflector element control should preferably implement the absolute value (regardless of the previous setting of the reflector element). When a control element represents a differential value for the reflector element, the reflector element control should preferably implement an adjustment of the previous setting of the reflector element, wherein the adjustment corresponds to the differential value.

Each control coefficient may represent a phase value, according to some embodiments. For example, each control coefficient may be a complex number (e.g., with unitary magnitude). Alternatively or additionally, the first plurality of control coefficients may be a length N vector of control coefficients. In some embodiments, the first plurality of control coefficients may be expressed as s=[e^{jθ}^{₁}, . . . , e^{jθ}^{_{N}}]∈ [symbol] ^{N×1}, where θₙ represents a phase value of the n^{th} control coefficient, n=1, . . . , N, j=\sqrt{−1}, and [symbol] represents the space of complex numbers.

Typically, the first plurality is relatively large and the method 300 exemplifies an approach where the control coefficients are represented in a compressed form for transmission to the second node.

This is achieved in step 370 of the method 300, wherein the first plurality of control coefficients is represented by a second plurality of approximation coefficients for transmission to the second node. The second plurality is smaller than the first plurality to achieve compression.

Each approximation coefficient may represent a phase value, according to some embodiments. For example, each approximation coefficient may be a complex number (e.g., with unitary magnitude). Each approximation coefficient being a complex number may be represented in complex domain, or in angular domain.

The second plurality of approximation coefficients comprises two or more, P>1, groups of approximation coefficients. The groups may also be referred to as “factors”.

Each group represents a low rank approximation (LRA) of the first plurality of control coefficients, and each group, p=1, . . . . P, comprises a respective third plurality, Rₚ>0, of collections \tilde{s}ᵣ_{ₚ}^{(p)}, rₚ=1, . . . , Rₚ, of approximation coefficients. In some embodiments, Rₚ=R for all groups. In some embodiments, Rₚ may be different for at least two (e.g., all) of the groups. The third plurality may also be referred to as “factorization rank”.

The number of approximation coefficients of each collection for a group, p, may be denoted as Nₚ>1. Thus, the second plurality can be expressed as Σₚ₌₁^{P}RₚNₚ.

It should be noted that P, N, Nₚ, and Rₚ are integers.

As illustrated by sub-step 372, step 370 may comprise performing low rank approximation (LRA) based on the first plurality of control coefficients, for each of the two or more groups, LRA.

Generally, sub-step 372 may comprise performing any suitable LRA algorithm based on the first plurality of control coefficients. For example, a suitable tensor-based LRA algorithm may be used.

In some embodiments, the LRA algorithm comprises a singular value decomposition (SVD), a higher order singular value decomposition (HOSVD), or an alternating least squares (ALS) algorithm, as exemplified in “Tensor decompositions and applications” by Kolda, T. G., and Bader, B. W., Society for Industrial and Applied Mathematics (SIAM) review, 2009, vol. 51, no. 3, pp. 455-500.

When R>1, the ALS algorithm may be preferable. This is due to that the HOSVD entails additional rotation information that typically needs to be sent with the approximation coefficients, implying R^{P} additional feedback bits.

As illustrated by sub-step 371, step 370 may comprise rearranging the first plurality of control coefficients for each of the two or more groups before performing the low rank approximation. The rearrangement may be different for at least two (e.g., all) of the groups. Alternatively or additionally, the rearrangement for one of the groups may be an identity rearrangement. Typically, the type of LRA applied implies whether and/or how rearrangement might be performed. For example, the rearrangement may comprise arranging the elements of s in respective matrices S^{(p)}, wherein each matrix has size (Nₚ×N₁ . . . Nₚ₋₁Nₚ₊₁ . . . N_{P}). When two matrices have the same dimensions, the element arrangements typically differ.

In some embodiments, step 370 may comprise normalizing each of the approximation coefficients (e.g., to unitary magnitude), as illustrated by sub-step 373.

Alternatively or additionally, step 370 may comprise quantizing each of the approximation coefficients, as illustrated by sub-step 374.

As illustrated by optional step 380, the approximation coefficients may be transmitted to the second node to control the radio reflector (compare with 204 of FIG. 2).

As illustrated by optional step 310, the method 300 may further comprise determining one or more parameters associated with the second plurality of approximation coefficients.

Alternatively or additionally, one or more parameters associated with the second plurality of approximation coefficients may be determined by a third node (compare with the control node 150 of FIG. 1 and/or the control node 250 of FIG. 2) and provided (e.g., transmitted) to the first node. Thus, optional step 310 may be replaced, or supplemented, by a step of receiving one or more parameters associated with the second plurality of approximation coefficients from the third node (compare with 200 of FIG. 2).

Generally, all parameters associated with the second plurality of approximation coefficients may be determined by the first node, or all parameters associated with the second plurality of approximation coefficients may be determined by the third node (or different parameters may be determined by different third nodes), or some parameters associated with the second plurality of approximation coefficients may be determined by the first node and some other parameters associated with the second plurality of approximation coefficients may be determined by the third node (or different ones of the other parameters may be determined by different third nodes).

Determination of the one or more parameters associated with the second plurality of approximation coefficients will be exemplified in the following for the first node. It should be noted that corresponding examples are equally applicable when parameter(s) associated with the second plurality of approximation coefficients are determined by a third node.

Typically, the determination implements a trade-off between control accuracy and signaling overhead.

The one or more parameters associated with the second plurality of approximation coefficients may comprise one or more of: the number of groups, P, the number of collections of each group, Rₚ, the number of approximation coefficients of each collection for each group, Nₚ, and a resolution for representing (e.g., by quantization) approximation coefficients for each group (e.g., expressed as a number of bits, bᵣ_{ₚ}^{(p)}, used to represent an approximation coefficient).

Generally, the resolution may be the same for all groups, or may be different for at least two (e.g., all) of the groups.

Also generally, any suitable method may be used to determine the one or more parameters. For example, a look-up table may be used, where the size of the first plurality, N, and possible some scenario specifics (e.g., traffic load, number or users, channel conditions (e.g., channel rank), etc.) may be used to look-up a suitable entry specifying the determined parameter(s), or a determination algorithm may be applied wherein the parameter(s) are calculated.

Typically, the determination is, at least to some extent, jointly performed for different parameters, as will be exemplify in the following.

Determining the number of groups, P, may comprise increasing the number of groups to decrease a size of the second plurality (i.e., to increase compression). Thus, a first number of groups may be determined to achieve a first size of the second plurality and a second number of groups may be determined to achieve a second size of the second plurality, wherein the first number of groups is larger than the second number of groups when the first size of the second plurality is smaller than the second size of the second plurality.

Alternatively or additionally, determining the number of groups, P, may comprise decreasing the number of groups to improve the representation of the first plurality of control coefficients by the second plurality of approximation coefficients (i.e., to increase accuracy of the radio reflector control). Thus, a first number of groups may be determined to achieve a first accuracy of the radio reflector control and a second number of groups may be determined to achieve a second accuracy of the radio reflector control, wherein the first number of groups is larger than the second number of groups when the first accuracy of the radio reflector control is lower than the second accuracy of the radio reflector control.

The parameter P may be seen as defining the total number of factors used for low-rank factorization. The minimum value is typically P=2 (when P=1, there is no factorization). By increasing the value of P, the number of factors are increased, which enables reduction of the size of each factor component Nₚ and/or reduction of the feedback signaling overhead. By decreasing the value of P (e.g., its minimum value), the number of factors are decreased, which enables increase of the size of each factor component Nₚ and/or increase of the spectral efficiency.

Determining the number of collections of each group, Rₚ, may comprise determining the number of collections to be the same for all groups or determining the number of collections to be different for at least two (e.g., all) of the groups.

Alternatively or additionally, determining the number of collections of each group, Rₚ, may comprise determining the number of collections of a group to equal, or exceed, a channel rank. It should be noted, however, that the number of collections of each group does not have to equal, or exceed, the channel rank. In some embodiments, the channel rank is used as a more general guidance (e.g., selecting a relatively large number of collections for each group when the channel rank is relatively high). In some embodiments, determining the number of collections of each group does not involve consideration of the channel rank at all.

Yet alternatively or additionally, determining the number of collections of each group, Rₚ, may comprise increasing the number of collections of a group to increase an accuracy of the LRA (i.e., to increase accuracy of the radio reflector control). Thus, a first number of collections may be determined to achieve a first accuracy of the radio reflector control and a second number of collections may be determined to achieve a second accuracy of the radio reflector control, wherein the first number of collections is larger than the second number of collections when the first accuracy of the radio reflector control is higher than the second accuracy of the radio reflector control.

Yet alternatively or additionally, determining the number of collections of each group, Rₚ, may comprise decreasing the number of collections of a group to decrease a size of the second plurality (i.e., to increase compression). Thus, a first number of collections may be determined to achieve a first size of the second plurality and a second number of collections may be determined to achieve a second size of the second plurality, wherein the first number of collections is larger than the second number of collections when the first size of the second plurality is larger than the second size of the second plurality.

The parameter Rₚ may be seen as a performance indicator. When it is increased, the approximation error of the low-rank factorization is reduced. The value of Rₚ may be selected based on the channel estimation. For example, if the channel estimation indicate channel(s) with low rank and/or channel(s) involving a strong line-of-sight (LoS) component, R=1 may be selected. Also, a relatively low value of R entails a relatively small size for the feedback signaling overhead. On the other hand, by increasing the value of R, the spectral efficiency may be increased.

Determining the number of approximation coefficients of each collection for each group, Nₚ, may comprise determining the number of approximation coefficients of each collection for each group so that a product over all groups of the number of approximation coefficients of each collection equals the first plurality, N (i.e., N=Σₚ₌₁^{P}Nₚ).

Alternatively or additionally, determining the number of approximation coefficients of each collection for each group, Nₚ, may comprise determining the number of approximation coefficients of each collection for each group so that a sum over all groups of the number of approximation coefficients of each collection is maximized (i.e., maximizing Σₚ₌₁^{P}Nₚ).

Yet alternatively or additionally, determining the number of approximation coefficients of each collection for each group, Nₚ, may comprise increasing the number of approximation coefficients of each collection for each group to increase an accuracy of the radio reflector control. Thus, a first number of approximation coefficients of each collection for each group may be determined to achieve a first accuracy of the radio reflector control and a second number of approximation coefficients of each collection for each group may be determined to achieve a second accuracy of the radio reflector control, wherein the first number of approximation coefficients of each collection for each group is larger than the second number of approximation coefficients of each collection for each group when the first accuracy of the radio reflector control is higher than the second accuracy of the radio reflector control.

Yet alternatively or additionally, determining the number of approximation coefficients of each collection for each group, Nₚ, may comprise decreasing the number of approximation coefficients of each collection for each group to decrease a size of the second plurality (i.e., to increase compression). Thus, a first number of approximation coefficients of each collection for each group may be determined to achieve a first size of the second plurality and a second number of approximation coefficients of each collection for each group may be determined to achieve a second size of the second plurality, wherein the first number of approximation coefficients of each collection for each group is larger than the second number of approximation coefficients of each collection for each group when the first size of the second plurality is larger than the second size of the second plurality.

Yet alternatively or additionally, determining the number of approximation coefficients of each collection for each group, Nₚ, may comprise decreasing the number of approximation coefficients of each collection for each group to when the number of groups, P, is increased (e.g., to compensate for decreased accuracy of the radio reflector control caused by the increase of the number of groups). Thus, a first number of approximation coefficients of each collection for each group may be determined for a first number of groups and a second number of approximation coefficients of each collection for each group may be determined for a second number of groups, wherein the first number of approximation coefficients of each collection for each group is larger than the second number of approximation coefficients of each collection for each group when the first number of groups is smaller than the second number of groups.

Yet alternatively or additionally, determining the number of approximation coefficients of each collection for each group, Nₚ, may comprise determining the number of approximation coefficients of each collection for each group so that the number of approximation coefficients of each collection for a first one of the groups equals a highest divisor of the first plurality. In some embodiments, determining the number of approximation coefficients of each collection for each group, Nₚ, may further comprise determining the number of approximation coefficients of each collection for each group so that the number of approximation coefficients of each collection for a second one of the groups equals a next highest divisor of the first plurality. In some embodiments, determining the number of approximation coefficients of each collection for each group, Nₚ, such that the P highest divisors of the first plurality are represented by Nₚ, p=1, . . . , P.

The parameter indicating size of the factor components Nₚ may be seen as implying the total number of approximation coefficients, and/or may be seen as dictating performance. The minimum value is Nₚ=2.

For example, for N=256, P=2, and R=1, two possible choices are N₁=128, N₂=2 and N₁=N₂=16. For the first choice, the number of approximation coefficients becomes higher than for the second choice (130 and 32, respectively), entailing better spectral efficiency and higher feedback signaling overhead. If performance is prioritized given a certain selection of P and Rₚ, one approach for choosing Nₚ is to choose N₁ as the P-th highest divisor of N, N₂ as the (P−1)-th highest divisor of N/N₁, Nₚ as the (P−p)-th highest divisor of N/(N₁ . . . Nₚ₋₁), and so on.

Determining the resolution for representing approximation coefficients for each group, bᵣ^{(p)}, may comprise determining the resolution for representing approximation coefficients to be the same for all groups, or determining the resolution for representing approximation coefficients to be different for at least two (e.g., all) of the groups.

Alternatively or additionally, determining the resolution for representing approximation coefficients for each group may comprise increasing the resolution for representing approximation coefficients for at least one of the groups when the number of collections for each group, Rₚ, is decreased. Thus, a first resolution may be determined for a first number of collections for each group and a second resolution may be determined for a second number of collections for each group, wherein the first resolution is larger than the second resolution when the first number of collections for each group is smaller than the second number of collections for each group.

Yet alternatively or additionally, determining the resolution for representing approximation coefficients for each group may comprise increasing the resolution for representing approximation coefficients for at least one of the groups when the number of approximation coefficients of each collection for each group, Nₚ, is decreased. Thus, a first resolution may be determined for a first number of approximation coefficients of each collection for each group and a second resolution may be determined for a second number of approximation coefficients of each collection for each group, wherein the first resolution is larger than the second resolution when the first number of approximation coefficients of each collection for each group is smaller than the second number of approximation coefficients of each collection for each group. Put differently, determining the resolution for representing approximation coefficients for each group may comprise determining the resolution for representing approximation coefficients for a first group to be higher than the resolution for representing approximation coefficients for a second group when the number of approximation coefficients of each collection for the first group is lower than the number of approximation coefficients of each collection for the second group.

The resolution may be seen as indicating the number of bits used for quantization of the approximation coefficients, and/or as indicative of the spectral efficiency. Each factor may have a different resolution. For example, if N=256, P=2, R=1, N₁=128, N₂=2, the first factor (128 elements) may be quantized using, e.g., one bit resolution, while the second factor (2 elements) may be quantized using a higher number of bits. The bit allocation (e.g., the number of approximation coefficients of each collection and/or the resolution) may be adjusted based on the feedback payload size.

In summary, the parameter values may be seen as representing a trade-off between the feedback signaling overhead and the reflector control performance (e.g., in terms of spectral efficiency and/or accuracy). In some embodiments, the feedback duration can be reduced by setting R=1 and increasing P to allow reduction of Nₚ. In some embodiments, the performance may be improved by selecting a higher value for R and a minimum value for P to allow increase of Nₚ (and possibly different number of quantization bits bᵣ^{(p)}).

As illustrated by optional step 390, the parameters may be adapted dynamically. When parameters are to be adapted (Y-path out of step 390), the method proceeds to step 310. Otherwise, the method handles a new batch of control coefficients without parameter adaptation, as illustrated by the N-path out of step 370.

It should be noted that different parameters may be adapted/updated (i.e., determined) at different times (e.g., with different periodicity). For example, some parameters (e.g., P and/or Nₚ) may be considered as semi-static and may only be updated relatively seldom, while other parameters (e.g., Rₚ and/or bᵣ_{ₚ}^{(p)}) may be considered as dynamic and may be updated relatively often.

Alternatively or additionally, a parameter adaptation/update may be associated with each transmission of approximation coefficients, or may be performed more seldom.

In some embodiments, the determination (i.e., parameter adaptation/update) is performed responsive to elapse of a specific time duration since a previous determination. The specific time duration may implement periodical parameter updates, for example, wherein the periodicity may be static or dynamically adjustable.

Alternatively or additionally, the determination of parameter(s) may be performed responsive to occurrence of a triggering event (e.g., changing channel conditions (such as channel rank), worsened performance, etc.).

The determination of parameter(s) may be based on a payload size of a packet for transmission of the approximation coefficients. For example, the second plurality and/or the resolution may be selected to match (or at least not exceed) the payload size.

Alternatively or additionally, the determination of parameter(s) may be based on an available capacity (e.g., bandwidth and/or power) for transmission of the approximation coefficients. For example, the second plurality and/or the resolution may be selected to match (or at least not exceed) the available bandwidth.

Yet alternatively or additionally, the determination of parameter(s) may be based on a traffic load on a channel used for transmission of the approximation coefficients. For example, the second plurality and/or the resolution may be decreased with increasing traffic load.

Yet alternatively or additionally, the determination of parameter(s) may be based on an update rate for the radio reflector control (i.e., how often coefficients should be sent). For example, the second plurality and/or the resolution may be decreased with increasing update rate.

Yet alternatively or additionally, the determination of parameter(s) may be based on a channel variability (e.g., mobility, fast fading, etc.). For example, the second plurality and/or the resolution may be decreased with increasing channel variability.

Yet alternatively or additionally, the determination of parameter(s) may be based on an accuracy for the radio reflector control. For example, the second plurality and/or the resolution may be increased for increasing accuracy for the radio reflector control.

Yet alternatively or additionally, the determination of parameter(s) may be based on a number of users for which approximation coefficients are to be provided. For example, the second plurality and/or the resolution may be decreased for accommodating an increased number of users.

As illustrated by optional step 330, information indicative of one or more parameters associated with the second plurality of approximation coefficients to the second node (termed “associated information” in FIG. 3), may be transmitted to the second node (compare with 203 of FIG. 2). The second node typically uses such information to estimate the control coefficients based on the approximation coefficients.

The information may be transmitted in association with the determination of step 310 as implied by FIG. 3. Alternatively or additionally, the information may be transmitted in association with (e.g., together with) the transmission of the approximation coefficients in step 380. In some embodiments, some of the information is transmitted in association with the determination and some (other) information is transmitted in association with the transmission of the approximation coefficients.

Other information than that indicative of the parameter(s) may also be transmitted to the second node (e.g., information indicative of how often coefficients are sent, and/or information indicative of weighting values for estimation of the control coefficients based on the approximation coefficients, and/or information indicative of a factorization model applied—e.g., PARAFAC model or Tucker model as described later herein).

As illustrated by optional step 320, the control signaling (i.e., the transmission of the approximation coefficients) may be adapted based on the parameter values. The adaptation may be performed before transmission of the parameter information as implied by FIG. 3, or at any other suitable point in time.

For example, the adaptation of the control signaling may comprise increasing an update rate for the radio reflector control when the size of the second plurality is decreased, and/or multiplexing approximation coefficients of two or more users within a same channel (when possible), and/or reducing bandwidth and/or power used for transmission of approximation coefficients when the size of the second plurality is decreased.

When there are limited resources to provide feedback, the adaptation of the control signaling may comprise reducing the total feedback signaling overhead.

Alternatively or additionally, the adaptation of the control signaling may comprise providing more frequent feedback updates, which may improve tracking of the propagation environment (e.g., for fast channel variations, mobility scenarios, etc.).

Yet alternatively or additionally, the adaptation of the control signaling may comprise multiplexing coefficient signaling associated with more users in the same feedback channel.

Yet alternatively or additionally, the adaptation of the control signaling may comprise increasing the quantization resolution, which may improve performance for a fixed feedback duration.

For each new batch of control coefficients, the method may comprise receiving reference signals (e.g., pilot signals, sounding signals, etc.) as reflected by the radio reflector, as illustrated by optional step 340 (compare with 202 of FIG. 2).

Typically, the reflector elements are not optimally configured when reflecting the reference signals (since the applicable control coefficients have not yet been conveyed). Therefore, the reference signals may be reflected by the radio reflector with reflector elements configured according to random control coefficient values, or according to default control coefficient values (e.g., based on truncated discrete Fourier transform, DFT, values), or according to previously provided control coefficient values.

For each new batch of control coefficients, the method may also comprise performing channel estimation based on the received reference signals (e.g., using any suitable channel estimation approach), as illustrated by optional step 350, and calculating the first plurality of control coefficients based on a channel estimation (e.g., using any suitable control coefficient calculation approach), as illustrated by optional step 360.

Generally, the update rate for radio reflector control and/or for one or more of the parameters associated with the second plurality of approximation coefficients may be the same for all dimensions of control (e.g., horizontal and vertical dimensions) or may differ for different dimensions of control. For example, the vertical dimension may be considered to be semi-static and corresponding updates may be performed relatively seldom, while the horizontal dimension may be considered to be dynamic (e.g., due to mobility of one or more of the communicating nodes) and corresponding updates may be performed relatively often.

Also generally, the update rate for radio reflector control and/or for one or more of the parameters associated with the second plurality of approximation coefficients may be the same for all reflector elements of the radio reflector, or may differ for different subsets of reflector elements of the radio reflector.

The first plurality of control coefficients may correspond to all reflector elements of the radio reflector, or the first plurality of control coefficients may correspond to a subset of the reflector elements of the radio reflector.

In the latter case, there may be two or more (non-overlapping) subsets of reflector elements. Typically, each reflector element of the radio reflector is comprised in exactly one subset.

A respective control coefficient compression as described herein may be applied to each of the subsets, or the control coefficients of one or more of the subsets may be transmitted uncompressed.

For example, method steps as described in connection with FIG. 3 may be independently applied to each subset. More specifically, step 370 may typically be independently performed for each subset.

The approach with two or more subsets is particularly useful when the first plurality, N, is a prime number (or is otherwise cumbersome, e.g., for fulfilment of N=Πₚ₌₁^{P}Nₚ). Then, the first plurality, N, can be split into two or more, X, subsets of first pluralities, N⁽¹⁾, . . . , N^{(X)}, where N=Σₓ₌₁^{X}N^{(x)}, and compression be applied to each subset. For example, if N=271, a split of N may be performed into two subsets of N⁽¹⁾=256 and N⁽²⁾=15 coefficients, respectively.

In the approach with two or more subsets, the method may also comprise transmitting (e.g., as described above for step 330 and/or in a preamble as exemplified later), to the second node, information indicative of one or more of: a number of subsets used, a first plurality size for each subset used, and one or more parameters associated with the second plurality of approximation coefficients for each subset used.

It should be noted that features described in connection with any of FIGS. 1-3 may—when suitable—be equally applicable for the method 300 of FIG. 3, even if not explicitly mentioned in connection thereto.

Application of the approaches explained in connection with step 370 enables the amount of feedback to be reduced considerably. Alternatively or additionally, application of the approaches explained in connection with step 370 enables the amount of feedback to be dynamically adapted.

The approaches explained in connection with step 370 may be seen as decomposition of a representation (e.g., a vector with N elements) of the control coefficients into a combination of smaller factors.

Instead of providing N control coefficients for reflector control, i.e., only Σₚ₌₁^{P}RₚNₚ«N approximation coefficients are provided. For example, if N=1024, P=10, Rₚ=R=2, and Nₚ=2, for p={1, . . . , 10}, the total number of approximation coefficients is 2(10·2)=40«1024.

FIG. 4 illustrates an example method 400 according to some embodiments. The method 400 is performed in a second node (e.g., the reflector node 120 of FIG. 1 and/or the reflector node 220 of FIG. 2), for controlling a radio reflector of the second node.

Generally, that the reflector is of the second node may be construed to mean that the reflector is comprised in the second node, or that the reflector is otherwise associated with (e.g., operatively connected, or connectable, to) the second node.

The control of the radio reflector is performed by using a first plurality, N>1, of control coefficients, wherein the radio reflector comprises reflector elements, and each reflector element is controllable by a respective one of the control coefficients.

For example, the method 400 may be performed by the second node in conjunction with the method 300 being performed by a corresponding first node (e.g., the control node 110 of FIG. 1 and/or the control node 210 of FIG. 2).

As illustrated by step 430, the method 400 comprises receiving a second plurality of approximation coefficients from the first node (compare with 204 of FIG. 2). The second plurality of approximation coefficients represents the first plurality of control coefficients, wherein the second plurality is smaller than the first plurality to achieve compression.

The second plurality of approximation coefficients comprises two or more, P>1, groups of approximation coefficients.

Each group represents a low rank approximation (LRA) of the first plurality of control coefficients, and each group, p=1, . . . P, comprises a respective third plurality, Rₚ>0, of collections \tilde{s}ᵣ_{ₚ}^{(p)}, rₚ=1, . . . , Rₚ, of approximation coefficients.

The number of approximation coefficients of each collection for a group, p, may be denoted as Nₚ>1. Thus, the second plurality can be expressed as Σₚ₌₁^{P}RₚNₚ.

For example, the second plurality of approximation coefficients received in step 430 may correspond to the second plurality of approximation coefficients transmitted in step 380 of FIG. 3.

As illustrated by step 440, the method 400 also comprises determining an estimation of the first plurality of control coefficients based on the second plurality of approximation coefficients.

In some embodiments, determining the estimation of the first plurality of control coefficients based on the second plurality of approximation coefficients may comprise calculating a number of Kronecker products of collections of approximation coefficients, and determining a (possibly weighted) sum of the calculated Kronecker products.

For example, the estimation s of the first plurality of control coefficients may be determined as ŝ=Σᵣ_{₁}₌₁^{R}^{₁} . . . Σᵣ_{_{P}}₌₁^{R}^{ₚ}gᵣ_{_{1, . . . ,}}ᵣ_{_{P}} (\tilde{s}ᵣ_{₁}⁽¹⁾⊗. . . ⊗\tilde{s}ᵣ_{_{P}}^{(P)}), where ⊗ represents the Kronecker product, and gᵣ_{_{1, . . . ,}} ᵣ_{_{P}} is a weighting factor. Thus, the factors of each Kronecker product may consist of exactly one collection \tilde{s}ᵣ_{ₚ}^{(p)} of approximation coefficients from each group, p=1, . . . , P, and the number of Kronecker products may be equal to a product of the respective third pluralities, R₁ . . . Rₚ. The weighting factors are typically determined jointly with the values of \tilde{s}ᵣ_{ₚ}^{(p)}.

This approach involving the Kronecker product for determining an estimation of the first plurality of control coefficients based on the second plurality of approximation coefficients are particularly applicable when the LRA is according to the Tucker model described later herein, and/or when the LRA is implemented using a singular value decomposition (SVD), a higher order singular value decomposition (HOSVD), or an alternating least squares (ALS) algorithm. It should be noted that other implementations of LRA may correspond to other approaches for determining an estimation of the first plurality of control coefficients based on the second plurality of approximation coefficients.

In another example (where the third pluralities are equal for all groups, Rₚ=R), the estimation ŝ of the first plurality of control coefficients may be determined as ŝ=Σᵣ₌₁^{R} (\tilde{s}ᵣ⁽¹⁾⊗. . . ⊗\tilde{s}ᵣ^{(P)}). Thus, the factors of each Kronecker product may consist of exactly one collection \tilde{s}ᵣ^{(p)} of approximation coefficients from each group, p=1, . . . , P, and the number of Kronecker products may be equal to the third plurality, R.

For example, if R=1 (i.e., there is only one term in the summation for ŝ), the p-th factor of the Kronecker product may be expressed as a complex-valued vector with elements

$${\tilde{s}}^{( p )} = [ {e}^{j {θ}_{1}^{( p )}} , … , {e}^{j {θ}_{{N}_{p}}^{( p )}} ] ,$$

and each control coefficient phase shift resulting from the Kronecker product may be expressed as a sum of P phase shifts (one phase shift from each group); i.e., θ₁=θ₁⁽¹⁾+θ₁⁽²⁾+. . . +θ₁^{(P)}, θ₂=θ₁⁽¹⁾+θ₁⁽²⁾ . . . +θ₂^{(P)}, etc.

This approach involving the Kronecker product for determining an estimation of the first plurality of control coefficients based on the second plurality of approximation coefficients are particularly applicable when the LRA is according to the PARAFAC model described later herein, and/or when the LRA is implemented using a singular value decomposition (SVD), a higher order singular value decomposition (HOSVD) provided that R=1, or an alternating least squares (ALS) algorithm. It should be noted that other implementations of LRA may correspond to other approaches for determining an estimation of the first plurality of control coefficients based on the second plurality of approximation coefficients.

In some embodiments, step 440 may further comprise normalizing each estimated control coefficient.

When the first plurality of control coefficients corresponds to a subset of the reflector elements of the radio reflector, step 440 may comprise determining respective estimations of the control coefficients based on the approximation coefficients for each subset, and concatenating the estimations of the first plurality of control coefficients for all used subsets.

As illustrated by optional step 450, the method 400 may further comprise controlling the reflector elements based on the estimation of the first plurality of control coefficients. The control of the reflector elements may apply any suitable approach for reflector element control.

As illustrated by optional step 410, the method 400 may further comprise receiving information indicative of one or more parameters associated with the second plurality of approximation coefficients from the first node (compare with 203 of FIG. 2). For example, the information received in step 410 may correspond to the information transmitted in step 330 of FIG. 3.

The information may be received separately as implied by FIG. 4. Alternatively or additionally, the information may be received in association with (e.g., together with) the reception of the approximation coefficients in step 430. In some embodiments, some of the information is received separately and some (other) information is received in association with the reception of the approximation coefficients.

The parameter information may be received for each reception of approximation coefficients, or may be received more seldom (e.g., at some periodicity, and/or when the parameter value is updated).

Other information than that indicative of the parameter(s) may also be received from the first node (e.g., information indicative of how often coefficients are sent, and/or information indicative of weighting values for estimation of the control coefficients based on the approximation coefficients).

In the approach with two or more subsets, the method may also comprise receiving (e.g., as described above for step 410), from the first node, information indicative of one or more of: a number of subsets used, a first plurality size for each subset used, and one or more parameters associated with the second plurality of approximation coefficients for each subset used.

The received information (e.g., regarding parameters) may be used for determining the estimation of the first plurality of control coefficients in step 440.

In some embodiments, the method 400 also comprises causing reference signals to be reflected by the radio reflector for channel estimation by the first node, as illustrated by optional step 420 (compare with 201, 202 of FIG. 2).

For example, the reference signals reflected according to step 420 may correspond to the reference signals received in step 340 of FIG. 3.

Typically, the reflector elements are not optimally configured when reflecting the reference signals (since the applicable control coefficients have not yet been conveyed). Therefore, the reference signals may be reflected by the radio reflector with reflector elements configured according to random control coefficient values, or according to default control coefficient values (e.g., based on truncated discrete Fourier transform, DFT, values), or according to previously provided control coefficient values.

The method 400 may be repeated as illustrated by the loopback from step 450 to step 410.

It should be noted that features described in connection with any of FIGS. 1-3 may—when suitable—be equally applicable for the method 400 of FIG. 4, even if not explicitly mentioned in connection thereto.

As already mentioned, any suitable LRA model may be used for provision of the reflector control feedback. Two examples are the Parallel Factor Analysis (PARAFAC) model and the Tucker model (which may be seen as a generalization of the PARAFAC model.

According to the PARAFAC model, the factorization may comprise providing sᵣ^{(p)}, p=1, . . . , P, r=1, . . . , R, such that s≈Σᵣ₌₁^{R}(sᵣ⁽¹⁾⊗. . . ⊗sᵣ^{(P)}), where sᵣ^{(p)} may correspond to \tilde{s}ᵣ^{(p)} before normalization and quantization. Possible algorithms for providing sᵣ^{(p)} for the PARAFAC model include ALS and HOSVD, wherein the latter is recommended only for R=1.

According to the Tucker model, the factorization may comprise providing sᵣ_{ₚ}^{(p)}, p=1, . . . , P, rₚ=1, . . . , Rₚ, such that s≈Σᵣ_{₁}₌₁^{R}^{₁} . . . Σᵣ_{_{P=1}}^{R}^{_{P}}gᵣ_{_{1, . . . ,}}ᵣ_{_{P}} (sᵣ_{₁}⁽¹⁾⊗. . . ⊗sᵣ_{_{P}}^{(P)}), where sᵣ_{ₚ}^{(p)} may correspond to \tilde{s}ᵣ_{ₚ}^{(p)} before normalization and quantization. Possible algorithms for providing sᵣ^{(p)} and gᵣ_{_{1, . . . ,}} ᵣ_{_{P}} for the Tucker model include ALS and HOSVD. The Tucker model is generalized from the PARAFAC model in that, Rₚ may be different for different groups p, a tensor of size R₁×. . . ×R_{P} with elements gᵣ_{_{1, . . . ,}} ᵣ_{_{P}} provides weighting values for the different terms, and the number of terms is increased from R to R₁+. . . +R_{P}.

For the Tucker model, the weighting values gᵣ_{_{1, . . . ,}}ᵣ_{_{P}} typically need to be provided to the second node at a signaling overhead cost of at least R₁R₂ . . . R_{P} bits.

If several models and/or algorithms are possible to apply for LRA, a choice between them may involve considering computational effort (e.g., overall computational effort, or computational effort for one of the involved nodes). Typically, the generalized Tucker model requires a higher computational effort than the PARAFAC model, and the ALS algorithm may require a higher computational effort than the HOSVD.

FIG. 5 schematically illustrates an example format for a signaling message 500 according to some embodiments. The signaling message 500 may, for example, be used to convey the second plurality of approximation coefficients (compare with 204 of FIG. 2 and/or step 380 of FIG. 3 and/or step 430 of FIG. 4), and/or to convey the information related to the approximation coefficient signaling; e.g., information indicative of one or more parameters associated with the second plurality of approximation coefficients (compare with 203 of FIG. 2 and/or step 330 of FIG. 3 and/or step 410 of FIG. 4).

The signaling message 500 is configured to be transmitted by a first node and received by a second node, for controlling a radio reflector of the second node by using a first plurality of control coefficients, as elaborated on above.

For example, the signaling message may be comprised in a radio resource control (RRC) message, a medium access control (MAC) message, or a relay type message (e.g., a message as specified for type 2 relay nodes or type 3 relay nodes).

The signaling message comprises a preamble portion 510 and a payload portion 520.

The payload portion 520 is configured to convey the second plurality of approximation coefficients representing the first plurality of control coefficients, as described above.

For example, the approximation coefficients of different groups may be comprised in different parts 523, . . . , 525 of the payload portion.

The preamble portion 510 is configured to convey information indicative of one or more parameters associated with the second plurality of approximation coefficients, as described above.

For example, information regarding different parameters may comprised in different parts 511, 512, 513, . . . , 515 of the preamble portion.

In some embodiments, a first part 511 comprises information regarding a number of groups, P, a second part 512 comprises information regarding a number of collections of each group, R₁, . . . , R_{P}, a third part 513 comprises information regarding a number of approximation coefficients of each collection for each group, N₁, . . . , N_{P}, and a fourth part 515 comprises information regarding a resolution for representing approximation coefficients for each group.

It should be noted that numerous variations for the preamble structure can be envisioned. For example, the order of information in the preamble portion may be different, and/or some information may be implicit.

Referring to the above example of the duration of time T_{F} needed for provision of the feedback, this duration of time may (assuming that Rₚ=R, and denoteing the number of bits in the preamble by T^{pre}) be reduced to

$${T}_{F} = ( {T}^{pre} + {\sum }_{p = 1}^{P} {\sum }_{r = 1}^{R} {N}_{p} {b}_{r}^{( p )} ) / {B}_{F} {log}_{2} ( 1 + \frac{{p}_{F} {\vert {h}_{F} \vert}^{2}}{{N}_{0} {B}_{F}} )$$

according to some embodiments.

For example, if N=1024, P=10, R=2, Nₚ=2, and bᵣ^{(p)}=2, the preamble may require at least four bits to represent P=10, two bits to represent R=2, and 2(10·2) bits to provide information (for each of P=10 groups) regarding the number of approximation coefficients of each collection (minimum two bits to represent Nₚ=2) and the resolution (minimum two bits to represent bᵣ^{(p)}=2) (i.e., a total of 46 bits for the preamble), while the payload may comprise a total of 2·2(10·2)=80 bits. Thus, the signaling message (e.g., a feedback frame) may require 126 bits in this compressed version; compared to 2·1024=2048 bits in the uncompressed version.

It should be noted that features described in connection with any of FIGS. 1-4 may—when suitable—be equally applicable for the signaling message 500 of FIG. 5, even if not explicitly mentioned in connection thereto.

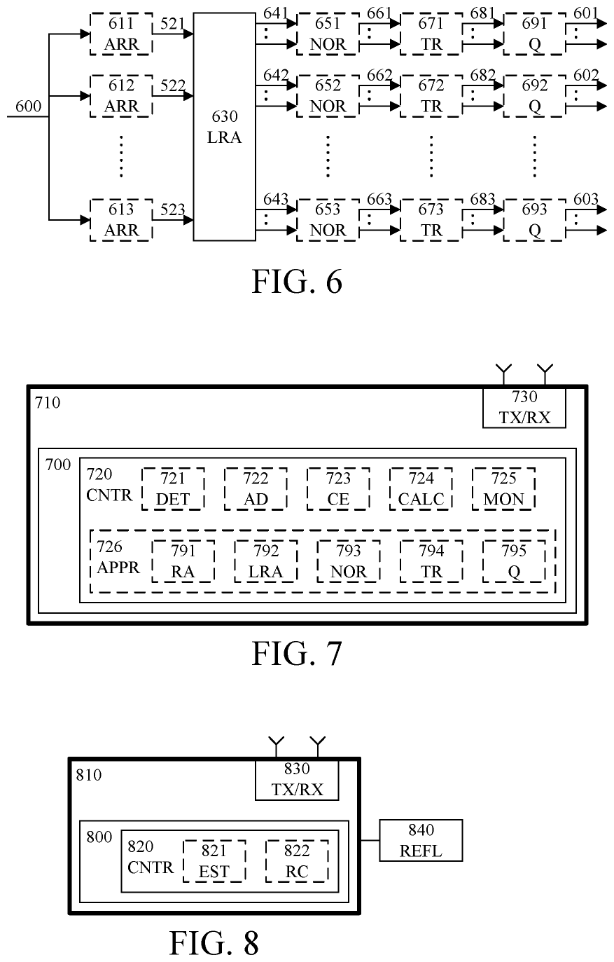

FIG. 6 schematically illustrates an example approach for representing a first plurality of control coefficients 600 by a second plurality of approximation coefficients 601, 602, 603 according to some embodiments.

For example, the approach of FIG. 6 may be applied by a first node (e.g., the control node 110 of FIG. 1 and/or the control node 210 of FIG. 2 and/or the first node performing step 370 of FIG. 3), and the second plurality of approximation coefficients may be for transmission to a second node (e.g., the reflector node 120 of FIG. 1 and/or the reflector node 220 of FIG. 2 and/or the second node performing step 430 of FIG. 4).

The first plurality of control coefficients 600 are rearranged for each group (compare with sub-step 371 of FIG. 3), as illustrated by the optional arrangement blocks (ARR; e.g., arranging circuitry, or an arrangement module) 611, 612, 613, wherein each arrangement block represents a respective one of the P groups.

The rearranged control coefficients for each group 521, 522, 523 are subjected to low rank approximation (compare with sub-step 372 of FIG. 3), as illustrated by the low rank approximation block (LRA; e.g., LRA circuitry, or an LRA module) 630. The low rank approximation for each group 641, 642, 643 comprises Rₚ components (collections) of approximation coefficients, wherein each collection has size Nₚ.

The approximation coefficients 641, 642, 643 are normalized (compare with sub-step 373 of FIG. 3), as illustrated by the optional normalization blocks (NOR; e.g., normalizing circuitry, or a normalization module) 651, 652, 653, wherein each normalization block represents a respective one of the P groups.

The normalized approximation coefficients 661, 662, 663 are transformed into angular domain representation, as illustrated by the optional transformation blocks (TR; e.g., transforming circuitry, or a transformation module) 671, 672, 673, wherein each transformation block represents a respective one of the P groups.

The normalized and transformed approximation coefficients 681, 682, 683 are quantized (compare with sub-step 374 of FIG. 3), as illustrated by the optional quantization blocks (Q; e.g., quantizing circuitry, or a quantization module) 691, 692, 693, wherein each quantization block represents a respective one of the P groups.

The normalized, transformed, and quantized approximation coefficients 601, 602, 603 correspond to the second plurality of approximation coefficients, and may be transmitted to the second node, as elaborated on above.

It should be noted that features described in connection with any of FIGS. 1-5 may—when suitable—be equally applicable for the approach of FIG. 6, even if not explicitly mentioned in connection thereto.

FIG. 7 schematically illustrates an example apparatus 700 according to some embodiments. The apparatus 700 is for a first node 710, for controlling a radio reflector of a second node by using a first plurality of control coefficients.

For example, the apparatus 700 may be comprisable, e.g., comprised, in a first node 710. The first node 710 may be a control node (e.g., a network node, such as a radio access node, or a user equipment, UE; compare with the control node 110 of FIG. 1 and/or the control node 210 of FIG. 2 and/or the first node performing the method 300 of FIG. 3).

Alternatively or additionally, the apparatus 700 may be configured to cause performance of (e.g., perform) one or more steps of the method 300 described in connection with FIG. 3.

The apparatus 700 comprises a controller (CNTR; e.g., controlling circuitry or a control module) 720.

The controller 720 is configured to cause representation of the first plurality of control coefficients by a second plurality of approximation coefficients for transmission to the second node, as elaborated on previously herein (compare with step 370 of FIG. 3).

To this end, the controller 720 may comprise, or be otherwise associated with (e.g., connectable, or connected, to) an approximator (APPR; e.g., approximating circuitry or an approximation module) 726. The approximator 726 may be configured to represent the first plurality of control coefficients by the second plurality of approximation coefficients. For example, the approximator 726 may implement the example approach described in connection with FIG. 6.

The controller 720 may be configured to cause the representation of the first plurality of control coefficients by the second plurality of approximation coefficients by causing performance of LRA for each group, based on the first plurality of control coefficients (compare with sub-step 372 of FIG. 3 and/or block 630 of FIG. 6).

To this end, the controller 720 and/or the approximator 726 may comprise, or be otherwise associated with (e.g., connectable, or connected, to) a low rank approximator (LRA; e.g., low rank approximating circuitry or a low rank approximation module) 792. The low rank approximator 792 may be configured to perform LRA for each group, based on the first plurality of control coefficients.

The controller 720 may be configured to cause the representation of the first plurality of control coefficients by the second plurality of approximation coefficients by causing rearrangement of the first plurality of control coefficients for each group before performance of the LRA (compare with sub-step 371 of FIG. 3 and/or blocks 611, 612, 613 of FIG. 6).

To this end, the controller 720 and/or the approximator 726 may comprise, or be otherwise associated with (e.g., connectable, or connected, to) a rearranger (RA; e.g., rearranging circuitry or a rearrangement module) 791. The rearranger 791 may be configured to rearrange the first plurality of control coefficients for each group before performance of the LRA.

The controller 720 may be configured to cause the representation of the first plurality of control coefficients by the second plurality of approximation coefficients by causing normalization of each of the approximation coefficients (compare with sub-step 373 of FIG. 3 and/or blocks 651, 652, 653 of FIG. 6).

To this end, the controller 720 and/or the approximator 726 may comprise, or be otherwise associated with (e.g., connectable, or connected, to) a normalizer (NOR; e.g., normalizing circuitry or a normalization module) 793. The normalizer 793 may be configured to normalize each of the approximation coefficients.

The controller 720 may be configured to cause the representation of the first plurality of control coefficients by the second plurality of approximation coefficients by causing transformation of the approximation coefficients between different domains (compare with blocks 671, 672, 673 of FIG. 6).

To this end, the controller 720 and/or the approximator 726 may comprise, or be otherwise associated with (e.g., connectable, or connected, to) a transformer (TR; e.g., transforming circuitry or a transformation module) 794. The transformer 794 may be configured to transform the approximation coefficients between different domains.

The controller 720 may be configured to cause the representation of the first plurality of control coefficients by the second plurality of approximation coefficients by causing quantization of each of the approximation coefficients (compare with sub-step 374 of FIG. 3 and/or blocks 691, 692, 693 of FIG. 6).

To this end, the controller 720 and/or the approximator 726 may comprise, or be otherwise associated with (e.g., connectable, or connected, to) a quantizer (Q; e.g., quantizing circuitry or a quantization module) 795. The quantizer 795 may be configured to quantize each of the approximation coefficients.

The controller 720 may be configured to cause determination of one or more parameters (compare with step 310 of FIG. 3).

To this end, the controller 720 may comprise, or be otherwise associated with (e.g., connectable, or connected, to) a determiner (DET; e.g., determining circuitry or a determination module) 721. The determiner 721 may be configured to determine one or more parameters.

Alternatively or additionally, the controller 720 may be configured to cause reception of one or more parameters from a third node (compare with the control node 150 of FIG. 1 and/or the control node 250 of FIG. 2).

To this end, the controller 720 may comprise, or be otherwise associated with (e.g., connectable, or connected, to) a transceiver (TX/RX; e.g., transceiving circuitry or a transceiver module) 730. The transceiver 730 may be configured to receive one or more parameters from the third node.

The controller 720 may be configured to cause the one or more parameters to be determined responsive to elapse of a specific time duration since a previous determination and/or occurrence of a triggering event (compare with step 390 of FIG. 3).

To this end, the controller 720 may comprise, or be otherwise associated with (e.g., connectable, or connected, to) a monitor (MON; e.g., monitoring circuitry or a monitor module) 725. The monitor 725 may be configured to monitor elapse of the specific time duration since a previous determination and/or occurrence of the triggering event, and cause the one or more parameters to be determined accordingly.

The controller 720 may be configured to cause transmission of the approximation coefficients and/or associated information (e.g., indicative of parameters, update rate, weighting values, number of subsets, etc.) to the second node (compare with steps 330, 380 of FIG. 3).

To this end, the controller 720 may comprise, or be otherwise associated with (e.g., connectable, or connected, to) a transceiver (TX/RX; e.g., transceiving circuitry or a transceiver module) 730. The transceiver 730 may be configured to transmit the approximation coefficients and/or associated information to the second node.

The controller 720 may be configured to cause reception of reference signals as reflected by the radio reflector (compare with step 340 of FIG. 3).

To this end, the controller 720 may comprise, or be otherwise associated with (e.g., connectable, or connected, to) a transceiver (TX/RX; e.g., transceiving circuitry or a transceiver module) 730. The transceiver 730 may be configured to receive the reference signals.

The controller 720 may be configured to cause performance of channel estimation based on the received reference signals (compare with step 350 of FIG. 3).

To this end, the controller 720 may comprise, or be otherwise associated with (e.g., connectable, or connected, to) a channel estimator (CE; e.g., estimating circuitry or an estimation module) 723. The channel estimator 723 may be configured to perform the channel estimation.

The controller 720 may be configured to cause calculation of the first plurality of control coefficients based on a channel estimation (compare with step 360 of FIG. 3).

To this end, the controller 720 may comprise, or be otherwise associated with (e.g., connectable, or connected, to) a calculator (CALC; e.g., calculating circuitry or a calculation module) 724. The calculator 724 may be configured to calculate the first plurality of control coefficients.

The controller 720 may be configured to cause adaptation of the control signaling based on the parameters (compare with step 320 of FIG. 3).

To this end, the controller 720 may comprise, or be otherwise associated with (e.g., connectable, or connected, to) an adapter (AD; e.g., adapting circuitry or an adaptation module) 722. The adapter 722 may be configured to adapt the control signaling.

It should be noted that features described in connection with any of FIGS. 1-6 may—when suitable—be equally applicable for the apparatus 700 of FIG. 7, even if not explicitly mentioned in connection thereto.

In some embodiment, there is provided an example apparatus for a third node, for controlling a radio reflector of a second node by using a first plurality of control coefficients.

For example, the apparatus for the third node may be comprisable, e.g., comprised, in the third node. The third node may be a control node (e.g., a network node, such as a central node; compare with the control node 150 of FIG. 1 and/or the control node 250 of FIG. 2).

The apparatus for the third node comprises a controller (e.g., controlling circuitry or a control module).

The controller of the apparatus for the third node is configured to cause determination of one or more parameters.

To this end, he controller of the apparatus for the third node may comprise, or be otherwise associated with (e.g., connectable, or connected, to) a determiner (e.g., determining circuitry or a determination module). The determiner may be configured to determine one or more parameters.

The controller of the apparatus for the third node is configured to cause provision of the one or more determined parameters to a first node (compare with the control node 110 of FIG. 1 and/or the control node 210 of FIG. 2 and/or the first node performing the method 300 of FIG. 3 and/or the first node 710 of FIG. 7).

To this end, the controller of the apparatus for the third node may comprise, or be otherwise associated with (e.g., connectable, or connected, to) a transceiver (e.g., transceiving circuitry or a transceiver module). The transceiver may be configured to provide (e.g., transmit) the one or more parameters to the first node.

It should be noted that features described in connection with any of FIGS. 1-7 may—when suitable—be equally applicable for the apparatus for the third node, even if not explicitly mentioned in connection thereto.

FIG. 8 schematically illustrates an example apparatus 800 according to some embodiments. The apparatus 800 is for a second node 810, for controlling a radio reflector (REFL) 840 of the second node by using a first plurality of control coefficients.

For example, the apparatus 800 may be comprisable, e.g., comprised, in a second node 810. The second node 810 may be a reflector node (e.g., a network node; compare with the reflector node 120 of FIG. 1 and/or the reflector node 220 of FIG. 2 and/or the second node performing the method 400 of FIG. 4).

Alternatively or additionally, the apparatus 800 may be configured to cause performance of (e.g., perform) one or more steps of the method 400 described in connection with FIG. 4.

The apparatus 800 comprises a controller (CNTR; e.g., controlling circuitry or a control module) 820.

The controller 820 is configured to cause reception of a second plurality of approximation coefficients, and possibly associated information (e.g., indicative of parameters, update rate, weighting values, number of subsets, etc.), from a first node (compare with steps 410, 430 of FIG. 4).

To this end, the controller 820 may comprise, or be otherwise associated with (e.g., connectable, or connected, to) a transceiver (TX/RX; e.g., transceiving circuitry or a transceiver module) 830. The transceiver 830 may be configured to receive the second plurality of approximation coefficients, and possibly the associated information, from the first node.

The controller 820 is also configured to cause determination of an estimation of the first plurality of control coefficients based on the second plurality of approximation coefficients (compare with step 440 of FIG. 4).

To this end, the controller 820 may comprise, or be otherwise associated with (e.g., connectable, or connected, to) an estimator (EST; e.g., estimating circuitry or an estimation module) 821. The estimator 821 may be configured to determine the estimation of the first plurality of control coefficients based on the second plurality of approximation coefficients.

The controller 820 may be configured to cause control of the reflector elements based on the estimation of the first plurality of control coefficients (compare with step 450 of FIG. 4), and/or to cause reference signals to be reflected by the radio reflector for channel estimation by the first node.

To this end, the controller 820 may comprise, or be otherwise associated with (e.g., connectable, or connected, to) a reflector controller (RC; e.g., reflector controlling circuitry or a reflector control module) 822. The reflector controller 822 may be configured to control the reflector elements based on the estimation of the first plurality of control coefficients, and/or to cause reference signals to be reflected by the radio reflector.

It should be noted that features described in connection with any of FIGS. 1-7 may—when suitable—be equally applicable for the apparatus 800 of FIG. 8, even if not explicitly mentioned in connection thereto.

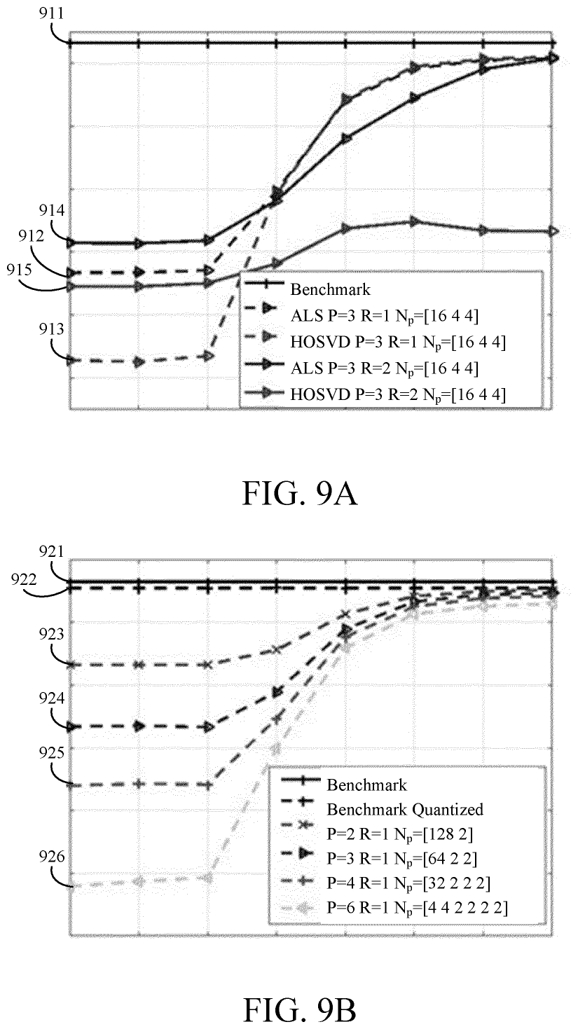

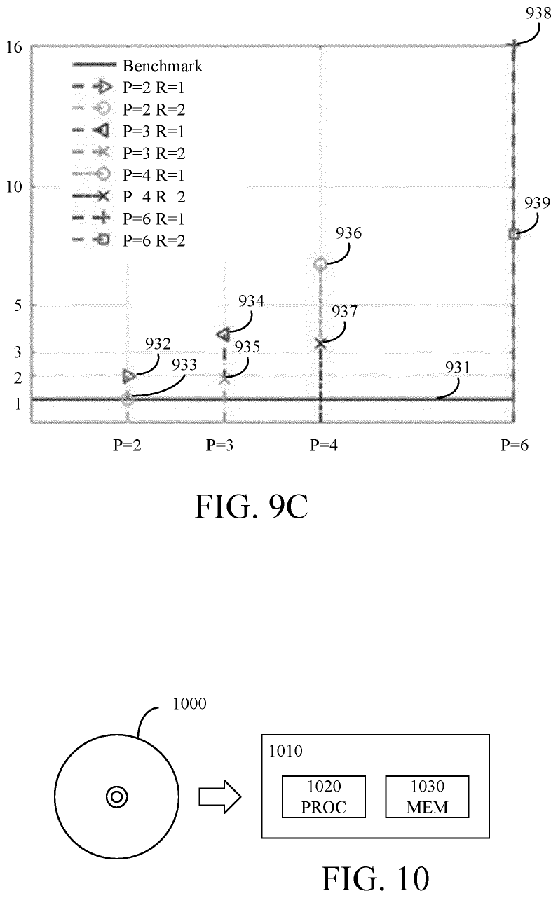

To illustrate merits of some embodiments, some performance results are provided in the following, with reference to FIGS. 9A-C showing simulation plots illustrating example results achievable according to some embodiments.

The performance results are for a SISO system aided by an IRS. The direct link between the first node (compare with 110 of FIG. 1) and the further node (compare with 130 of FIG. 1) is disregarded. The channel between the further node and the reflector is denoted by h of size (N×1), and the channel between the reflector and the first node is denoted by g of size (1×N). Both channels are generated by composition of a line-of-sight (LoS) component and a non-line-of-sight (NLoS) component, where the impact of each component is controlled by the Rician K-factor.

The optimum phase-shift associated with the n^{th} IRS element that maximizes the Signal-to-Noise Ratio (SNR) is given by θ(n)=−(∠g(n)+∠h(n)). The performance is evaluated in terms of achievable data rate in bits per second per Hertz (bps/Hz), by varying the Rician K-factor. The simulation parameters used for each of FIGS. 9A-C are shown in the following table.

| Parameter | FIG. 9A | FIG. 9B | FIG. 9C |
|---|---|---|---|
| N | 256 | 256 | 256 |
| P | 3 | 2, 3, 4, 6 | 2, 3, 4, 6 |
| Nₚ | 64, 2, 2 | for P = 2: 128, 2 | for P = 2: 128, 2 |
| | | for P = 3: 64, 2, 2 | for P = 3: 64, 2, 2 |
| | | for P = 4: 32, 2, 2, 2 | for P = 4: 32, 2, 2, 2 |
| | | for P = 6: 4, 4, 2, 2, 2, 2 | for P = 6: 4, 4, 2, 2, 2, 2 |
| R | 1, 2 | 1 | 1, 2 |
| bᵣ^{(p)} = b | 3 | 3 | 3 |

FIG. 9A shows performance of feedback-aware IRS using ALS with R=1 (912) and R=2 (914), and using HOSVD with R=1 (913) and R=2 (915), and provide comparison with a benchmark (optimum) approach (911). The x-axis represent the Rician K-factor with values from −15 to 20 dB, and the y-axis represents achievable data rate ranging from 13 to 20 bps/Hz.

The following number of bits are required for the payload portion of the feedback signaling: Nb=256·3=768 bits for the benchmark, (N₁+N₂+N₃)Rbᵣ^{(p)}=(64+2+2)·1·3=204 bits for HOSVD R=1, (N₁+N₂+N₃)Rbᵣ^{(p)}+R^{P}=(64+2+2)·2·3+2³=416 bits for HOSVD R=2, (N₁+N₂+N₃)Rbᵣ^{(p)}=(64+2+2)·1·3=204 bits for ALS R=1, and (N₁+N₂+N₃)Rbᵣ^{(p)}=(64+2+2)·2·3=408 bits for ALS R=2.

The impact of the choice of R is clearly illustrated. From FIG. 9A, it can be observed that when the channels are dominated by NLoS (low value of K; e.g., K<0 dB), increased R leads to improved performance at the cost of an increased feedback signaling overhead. However, as the LoS component becomes stronger (increasing K), choosing R=1 not only increases the performance, but also reduces the feedback signaling overhead.

FIG. 9B shows performance of feedback-aware IRS using ALS with P=2,3,4,5 (923, 924, 925, 926, respectively), and provide comparison with a benchmark (optimum) approach (921) as well as a benchmark (optimum quantized) approach (922). The x-axis represent the Rician K-factor with values from −15 to 20 dB, and the y-axis represents achievable data rate ranging from 8.5 to 11.5 bps/Hz.

The following number of bits are required for the payload portion of the feedback signaling: Nb=256·3=768 bits for the benchmark, (N₁+N₂)bᵣ^{(p)}=(128+2)·3=390 bits for P=2, (N₁+N₂+N₃)bᵣ^{(p)=(}64+2+2)·3=204 bits for P=3, (N₁+N₂+N₃+N₄)bᵣ^{(p)}=(32+2++2+2)·3=114 bits for P=4, and (N₁+N₂+N₃+N₄+N₅+N₆)bᵣ^{(p)}=(4+4+2+2+2+2)·3=48 bits for P=6.

The impact of the choice of P is clearly illustrated. From FIG. 9B, it can be observed that when the channels are dominated by NLOS (low value of K), there is a trade-off between data rate and feedback signaling overhead; i.e., increasing P reduces the feedback signaling overhead at the cost of data rate reduction. However, as the LoS component becomes stronger (increasing K; e.g., above 5 dB), the data rate becomes less sensitive to the choice of P, and a significant reduction of the feedback signaling overhead can be achieved by increasing P.

FIG. 9C shows the ratio between the number of feedback bits of the benchmark (optimum) approach and the number of feedback bits of some embodiments for different P and R. The x-axis represent P=2,3,4,6, and the y-axis represents the ratio ranging from 0 to 16. The ratio for P=2, R=1 is shown at 932, the ratio for P=2, R=2 is shown at 933, the ratio for P=3, R=1 is shown at 934, the ratio for P=3, R=2 is shown at 935, the ratio for P=4, R=1 is shown at 936, the ratio for P=4, R=2 is shown at 937, the ratio for P=6, R=1 is shown at 938, the ratio for P=6, R =2 is shown at 939, and the benchmark is shown by 931.

FIG. 9C illustrates required payload compared to the benchmark approach. The comparison is shown as a ratio for different choices for R and P. For P=2, R=1, the payload is two times smaller than for the benchmark. As P increases, the payload decreases further (i.e., the ratio increases). For P=6, R=1, the payload is 16 times smaller than for the benchmark. Further, it can be observed that the ratio decreases with increasing R.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a reflector node or a control node (e.g., a network node, such as a radio access node or a central node) for a wireless communication system.

Embodiments may appear within an electronic apparatus (such as a reflector node or a control node) comprising arrangements, circuitry, and/or logic according to any of the embodiments described herein. Alternatively or additionally, an electronic apparatus (such as a reflector node or a control node) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 10 illustrates an example computer readable medium in the form of a compact disc (CD) ROM 1000. The computer readable medium has stored thereon a computer program comprising program instructions. The computer program is loadable into a data processor (PROC; e.g., a data processing unit) 1020, which may, for example, be comprised in a reflector node or a control node 1010. When loaded into the data processor, the computer program may be stored in a memory (MEM) 1030 associated with, or comprised in, the data processor. According to some embodiments, the computer program may, when loaded into, and run by, the data processor, cause execution of method steps according to, for example, any of the methods illustrated in FIGS. 3 and 4, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method performed in a first node, for controlling a radio reflector of a second node by using a first plurality, N, of control coefficients, wherein the radio reflector comprises reflector elements, each reflector element being controllable by a respective one of the control coefficients, the method comprising:
representing the first plurality of control coefficients by a second plurality of approximation coefficients for transmission to the second node, wherein the second plurality is smaller than the first plurality, and wherein the second plurality of approximation coefficients comprises two or more, P, groups of approximation coefficients, each group representing a low rank approximation, LRA, of the first plurality of control coefficients, and each group comprising a respective third plurality, Rₚ, of collections of approximation coefficients.

2. The method of claim 1, further comprising transmitting the approximation coefficients to the second node to control the radio reflector.

3. The method of claim 1, further comprising transmitting information indicative of one or more parameters associated with the second plurality of approximation coefficients to the second node.

4. The method of claim 1, wherein representing the first plurality of control coefficients by the second plurality of approximation coefficients comprises performing, for each of the two or more groups, LRA based on the first plurality of control coefficients.

5. The method of claim 4, wherein representing the first plurality of control coefficients by the second plurality of approximation coefficients further comprises rearranging the first plurality of control coefficients for each of the two or more groups before performing the LRA.

6. The method of claim 4, wherein performing the LRA comprises performing one or more of: a singular value decomposition, SVD, a higher order singular value decomposition, HOSVD, and an alternating least squares, ALS, algorithm.

7. The method of claim 1, further comprising determining one or more of:
a number of groups;
a number of collections of each group;
a number of approximation coefficients of each collection for each group; and
a resolution for representing approximation coefficients for each group.

8-13. (canceled)

14. The method of claim 1, wherein representing the first plurality of control coefficients by the second plurality of approximation coefficients comprises one or more of:
normalizing each of the approximation coefficients; and
quantizing each of the approximation coefficients.

15. The method of claim 1, further comprising calculating the first plurality of control coefficients based on a channel estimation.

16. The method of claim 1, wherein the first plurality of control coefficients represents absolute, or differential, phase values for the reflector elements.

17. The method of claim 1, further comprising:
receiving reference signals as reflected by the radio reflector; and
performing channel estimation based on the received reference signals.

18. (canceled)

19. The method of claim 1, further comprising one or more of:
increasing an update rate for the radio reflector control when a size of the second plurality is decreased;
multiplexing approximation coefficients of two or more users within a same channel; and
reducing a bandwidth and/or power used for transmission of approximation coefficients when a size of the second plurality is decreased.

20. The method of claim 1, wherein one or more parameters associated with the second plurality of approximation coefficients differs for different dimensions of control and/or for different subsets of the reflector elements of the radio reflector.

21. The method of claim 1, wherein the first plurality of control coefficients corresponds to all reflector elements of the radio reflector.

22. The method of claim 1, wherein the first plurality of control coefficients corresponds to a subset of the reflector elements of the radio reflector.

23. (canceled)

24. A method performed in a second node, for controlling a radio reflector of the second node by using a first plurality, N, of control coefficients, wherein the radio reflector comprises reflector elements, each reflector element being controllable by a respective one of the control coefficients, the method comprising:
receiving a second plurality of approximation coefficients from a first node, wherein the second plurality of approximation coefficients represents the first plurality of control coefficients, wherein the second plurality is smaller than the first plurality, and wherein the second plurality of approximation coefficients comprises two or more, P, groups of approximation coefficients, each group representing a low rank approximation, LRA, of the first plurality of control coefficients, and each group comprising a respective third plurality, Rₚ, of collections of approximation coefficients; and
determining an estimation of the first plurality of control coefficients based on the second plurality of approximation coefficients.

25-34. (canceled)

35. A method performed in a third node, for controlling a radio reflector of a second node by using a first plurality, N, of control coefficients, wherein the radio reflector comprises reflector elements, each reflector element being controllable by a respective one of the control coefficients, and
wherein the first plurality of control coefficients are representable by a second plurality of approximation coefficients for transmission from a first node to the second node, wherein the second plurality is smaller than the first plurality, and wherein the second plurality of approximation coefficients comprises two or more, P, groups of approximation coefficients, each group representing a low rank approximation, LRA, of the first plurality of control coefficients, and each group comprising a respective third plurality, Rₚ, of collections of approximation coefficients,
the method comprising:
determining one or more parameters associated with the second plurality of approximation coefficients; and
providing the one or more determined parameters to the first node.

36-38. (canceled)

39. A computer program product comprising a non-transitory computer readable medium, having thereon a computer program comprising program instructions, the computer program being loadable into a data processing unit and configured to cause execution of the method according to claim 1 when the computer program is run by the data processing unit.

40. An apparatus for a first node, for controlling a radio reflector of a second node by using a first plurality, N, of control coefficients, wherein the radio reflector comprises reflector elements, each reflector element being controllable by a respective one of the control coefficients, the apparatus comprising controlling circuitry configured to cause:
representation of the first plurality of control coefficients by a second plurality of approximation coefficients for transmission to the second node, wherein the second plurality is smaller than the first plurality, and wherein the second plurality of approximation coefficients comprises two or more, P, groups of approximation coefficients, each group representing a low rank approximation, LRA, of the first plurality of control coefficients, and each group comprising a respective third plurality, Rₚ, of collections of approximation coefficients.

41-62. (canceled)

63. A control node comprising the apparatus of claim 40.

64-88.(canceled)
